(19) United States
(12) Patent Application Publication
(10) Pub. No.: US 2021/0044756 A1
(43) Pub. Date: Feb. 11, 2021

(54) DISPLAY AND IMAGING DEVICE

(71) Applicant: NTT DOCOMO, INC., Chiyoda-ku (JP)

(72) Inventor: Shinji KIMURA, Chiyoda-ku (JP)

(73) Assignee: NTT DOCOMO, INC., Chiyoda-ku (JP)

(21) Appl. No.: 17/041,353

(22) PCT Filed: Feb. 19, 2019
(86) PCT No.: PCT/JP2019/006087

§ 371 Date: Sep. 24, 2020

(30) Foreign Application Priority Data
Apr. 26, 2018 (JP) 2018-085070

(51) Int. Cl. H04N 5/232

(52) U.S. Cl. CPC H04N 5/232125; H04N 5/232123

(57) ABSTRACT

A display and imaging device includes a display of a transmissive type configured to receive an image as an input and display the image, a camera configured to image a side in front of the display from behind the display, a distance detecting unit configured to detect a distance from the camera to a target object of imaging using the camera and a depth of field control unit configured to control a depth of field of imaging using the camera in accordance with the detected distance.

### TECHNICAL FIELD

The present invention relates to a display and imaging device that performs imaging together with performing display of an image.

### BACKGROUND ART

Techniques for realizing video calls with eye contact have been proposed. Patent Literature 1 discloses a technique for imaging a user in front of a display using a camera disposed to the rear of a transmissive-type display that displays a call partner. According to this technique, a side in front of a user can be imaged in a state in which a user and a call partner displayed in a display face each other.

### CITATION LIST

### Patent Literature

[Patent Literature 1] Japanese Unexamined Patent Publication No. 2010-232828

### SUMMARY OF INVENTION

### Technical Problem

In the system described above, as a transmissive-type display, for example, it is conceivable that a transparent organic light emitting diode (OLED) display using an OLED be used. In the transparent OLED display, periodical structure members which are signal lines provided in a lattice pattern are included for driving organic electro-luminescence (EL) elements. When imaging is performed from behind the transparent OLED display using a camera, the periodic structure members are shown in an image acquired by the imaging, and thus, the image quality (the quality of the image) deteriorates.

One embodiment of the present invention has been made in view of the description presented above, and an object thereof is to provide a display and imaging device capable of preventing deterioration of image quality in a case in which imaging is performed from behind a transmissive-type display.

### Solution to Problem

In order to achieve the object described above, according to one embodiment of the present invention, a display and imaging device includes: a display of a transmissive type configured to receive an image as an input and display the image; a camera configured to image a side in front of the display from behind the display; a distance detecting unit configured to detect a distance from the camera to a target object of imaging using the camera; and a depth of field control unit configured to control a depth of field of imaging using the camera in accordance with the distance detected by the distance detecting unit.

In the display and imaging device according to one embodiment of the present invention, a depth of field of imaging using the camera is controlled in accordance with a distance from the camera to a target object of imaging using the camera such as a user or the like. In accordance with this control, a ghost image of a member such as a periodic structure member, which is included in a transmissive-type display, in an image can be reduced or eliminated. Therefore, according to the display and imaging device according to one embodiment of the present invention, in a case in which imaging is performed from behind the display of the transmissive type, deterioration of image quality can be prevented.

### Advantageous Effects of Invention

According to one embodiment of the present invention, a ghost image of a member such as a periodic structure member, which is included in a transmissive-type display, in an image can be reduced or eliminated, and deterioration of the image quality in a case in which imaging is performed from behind the transmissive-type display can be prevented.

### BRIEF DESCRIPTION OF DRAWINGS

FIG. 1 is a diagram illustrating the configuration of a display and imaging device according to an embodiment of the present invention.

FIG. 2 is a diagram schematically illustrating an image in which periodical structure members are shown and an image in which the periodical structure members are not shown.

FIG. 3 is a diagram illustrating an example of a set depth of field.

FIG. 4 is a diagram illustrating another example of a set depth of field.

FIG. 5 is a diagram illustrating setting of a depth of field.

FIG. 6 is a flowchart illustrating a process executed by a display and imaging device according to an embodiment of the present invention.

FIG. 7 is a diagram illustrating the hardware configuration of a PC included in a display and imaging device according to an embodiment of the present invention.

### DESCRIPTION OF EMBODIMENTS

Hereinafter, a display and imaging device according to an embodiment of the present invention will be described in detail with reference to the drawings. In description of the drawings, the same reference signs will be assigned to the same elements, and duplicate description will be omitted. In the drawings, the dimension ratios do not necessarily coincide with those presented in descriptions.

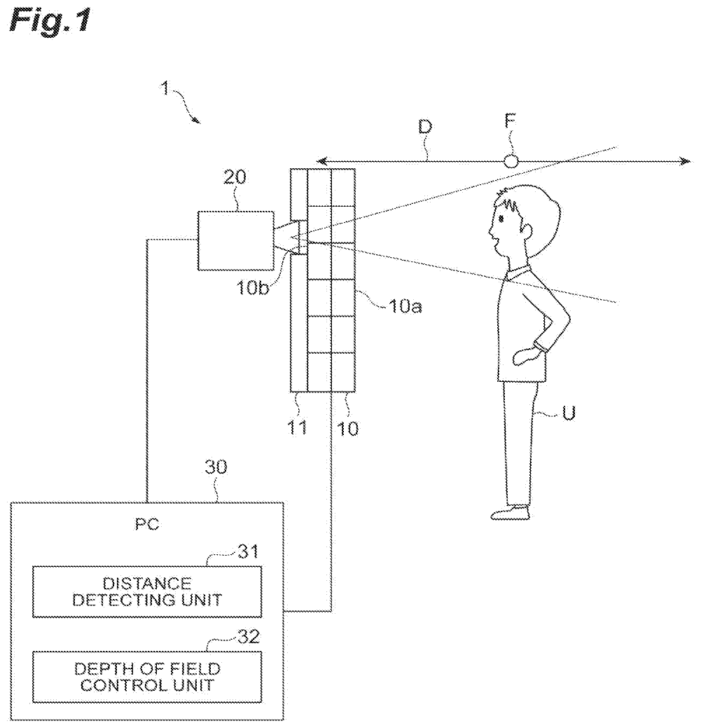

FIG. 1 illustrates a display and imaging device 1 according to this embodiment. The display and imaging device 1 is a device (system) that performs imaging (photographing) together with performing display of an image. The display and imaging device 1 is configured to include a display 10, a camera 20, and a personal computer (PC) 30. In this embodiment, the display and imaging device 1 is used for a video call (a television call). The display 10 displays an image (video) of a call partner. The camera 20 images a user U (person) using the display and imaging device 1. An image of the user U who has been imaged is transmitted to a call partner-side device used by the call partner for a video call. In addition, the call partner-side device may be a device having the same function as that of the display and imaging device 1 or a device having a function different from that of the display and imaging device 1. Generally, images that are transmitted or received between the display and imaging device 1 and the call partner-side device are moving images. The display and imaging device 1 and the call partner-side device input/output and transmit/receive voices for video calls.

The display 10 is a display (a transparent display) of a transmissive type (in other words, transmitting light) that displays an image according to the image being input. As the display 10, a conventional transmissive-type display may be used. For example, the display 10 may be a display of a self-light emitting type configured to include an OLED as display pixels, that is, a transparent OLED display. The display 10 does not need to be a transparent OLED display and need only to be a display of a transmissive type. The display 10 is connected to the PC 30 such that information can be transmitted and received therebetween and receives an image from the PC 30 and displays the image on a rectangular display face that is a front face 10a. In FIG. 1, the display face that is the front face 10a of the display 10 extends in a depth direction (horizontal direction) of the sheet face and in a perpendicular direction (vertical direction) of the sheet face.

The camera 20 is a device that images a side in front of the display 10 from behind the display 10. For example, the camera 20 acquires a plurality of captured images that are continuous in a time series by repeating imaging at a predetermined imaging frame rate. As the camera 20, a conventional camera that generates a moving image by performing imaging can be used. For example, a conventional single-lens reflex camera may be used as the camera 20. Alternatively, a smartphone having a camera function may be used as the camera 20. In a case in which a smartphone is used as the camera 20, functions of the PC 30 to be described below may be realized by the smartphone.

The camera 20 is positioned on a rear face 10b side of the display 10 in advance to be disposed. The camera 20 is disposed such that an imaging direction is a direction toward a rear face 10b of the display 10 and is perpendicular to the rear face 10b. In FIG. 1, the imaging direction of the camera 20 is a direction from the left side to the right side of a sheet face. In addition, the camera 20 is disposed in a state being in proximity to or in contact with the rear face 10b of the display 10. The imaging direction of the camera 20 may not be configured to be perpendicular to the rear face 10b of the display 10.

As described above, since the display 10 is a transmissive type, by disposing the camera 20 as described above, a side in front of the display 10 can be imaged through the display 10. As illustrated in FIG. 1, when a user U is positioned on the side in front of the display 10, the camera 20 can image the user U. The camera 20 is connected to the PC 30 such that it can transmit/receive information to/from the PC 30 and outputs a captured image to the PC 30.

When a video call is performed, a call partner is displayed on the display 10. A user U makes a call while viewing a face of the call partner displayed on the display 10. A position of the camera 20 in a horizontal direction and a vertical direction of the display 10 (a forward/backward direction and an upward/downward direction of the sheet face in FIG. 1) is set as a position at which the face of the call partner is displayed, in other words, a position of a sight line (an eye line) when the user U views the display 10. In accordance with the disposition of this camera 20, an image acquired through imaging using the camera 20 can be the one in which the sight line of the user U is directed.

The camera 20 can set a depth of field D at the time of imaging. In accordance with this setting, a length (depth) and a position of the depth of field D in an imaging direction are set. The depth of field D is a position based on a focus position (a focus center or a focus point) F. More specifically, a predetermined length before and after the focus position F in the imaging direction of the camera 20 is a depth of field D. An approximate center of the depth of field D in the imaging direction is a focus position F.

For example, the camera 20 includes a conventional mechanism that can change the focus position F. In addition, the camera 20 is a single-lens reflex camera having a diaphragm, and the length of the depth of field D can be set using the diaphragm. Alternatively, the camera 20 may have a plurality of imaging lenses that can set a varying depth of field D, and the length and the like of the depth of field D can be set depending on which of the lenses is used. The depth of field D is controlled by the PC 30 as will be described below.

In a part other than a part of the rear face 10b of the display 10 in which the camera 20 is installed, a non-transparent masking member (mask) 11 may be disposed to cover the part. In the part of the masking member 11 in which the camera 20 is installed, a hole corresponding to parts of the camera 20 such as a lens and the like that performs imaging is formed. As the masking member 11, a member that does not easily reflect light (particularly, easily absorbs light), for example, a cloth, a plate, or the like may be used. In addition, in order to make it more difficult to reflect light, the masking member 11 may have a black color. The masking member 11 has an area that is almost the same as the area of the rear face 10b of the display 10. The masking member 11 is disposed in a state being in proximity to or in contact with the rear face 10b of the display 10. By thus disposing the masking member 11, the side to the rear of the display 10 can be configured not to be seen from the side in front of the display 10, and the camera 20 can be configured not to be visually standing out (hidden).

In this way, the visibility of the display 10 can be improved.

In a case in which the side in front of the display 10 is imaged from behind the display 10 using the camera 20, the following problems may occur. In an inner side of the display face of the display 10 that is a transparent OLED display, periodical structure members which are signal lines provided in a lattice pattern for driving organic EL elements (light emitting elements) are included. The signal lines, for example, are disposed such that they surround individual display pixels (sub-pixels) formed from organic EL elements corresponding to the three primary colors R, G, and B. In accordance with electrical signals (control signals and the like) from the signal lines, luminance values of light emitting elements of display pixels are adjusted. In the display 10, members required for wiring signal lines and the like may be included in addition thereto. In addition, a plurality of display pixels (sub-pixels) may be included inside one lattice cell configured by the periodical structure members. For example, in a case in which one signal line extending in the horizontal direction drives light emitting elements of display pixels positioned on both sides of the signal line, two display pixels may be included inside one lattice cell in the vertical direction. In a case in which one signal line extending in the vertical direction drives light emitting elements of display pixels positioned on both sides of the signal line, two display pixels may be included inside one lattice cell in the horizontal direction. Since the number of display pixels included in one lattice cell is flexible, the shape of the lattice may be a rectangle (not limited to a square).

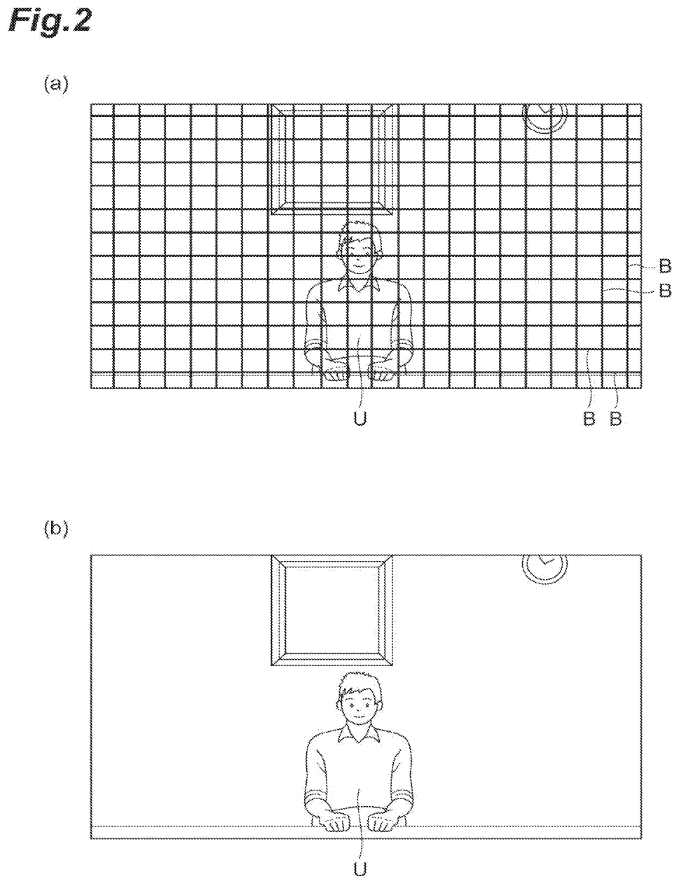

Although the display 10 is of a transmissive type, members such as the periodical structure members and the like described above do not transmit light. For this reason, when a side in front of the display 10 is imaged from behind the display 10, such members included in the display 10 are shown in an image acquired through the imaging. For example, as illustrated in FIG. 1, when the depth of field D reaches to a part of the display 10, as illustrated in FIG. 2(a), periodical structure members B having a lattice pattern is shown in an image mainly in a black color. This ghost image applies also for a user who is making a video call. In other words, the image quality when making a video call deteriorates. This embodiment is for preventing deterioration of the image quality. In addition, also in a case in which the display 10 is a display of a transmissive type other than a transparent OLED display, the problems as described above may occur.

The PC 30 is a device that controls the depth of field D of imaging using the camera 20 for preventing deterioration of the image quality. As described above, the PC 30 is connected to the camera 20 such that information can be transmitted/received therebetween and can transmit/receive information to/from the camera 20.

In addition, the PC 30 transmits/receives images to/from a call partner-side device. As described above, the PC 30 is connected also to the display 10 such that information can be transmitted and received therebetween and can transmit/receive information to/from the display 10. The PC 30 receives an image from the call partner-side device and outputs the received image to the display 10. The PC 30 receives an image that has been acquired by the camera 20 through imaging from the camera 20 as an input and transmits the received image to the call partner-side device. In this embodiment, although control of the depth of field D and transmission/reception of images to/from the call partner-side device are performed by one device (the PC 30), those may be performed by different devices. In addition, the PC 30 may be substituted with a computer other than the PC 30 such as a server apparatus or a smartphone.

As illustrated in FIG. 1, the PC 30 is configured to include a distance detecting unit 31 and a depth of field control unit 32 as functional components relating to control of the depth of field D.

The distance detecting unit 31 is a functional unit that detects a distance from the camera 20 to a target object for imaging using the camera 20. The distance detecting unit 31 may detect a position at which a target object is shown in an image acquired by imaging using the camera 20 and detect a distance on the basis of the detected position. In this embodiment, a target object for imaging using the camera 20 is a user U who is making a video call. For example, the distance detecting unit 31 detects a distance as below.

The distance detecting unit 31 receives an image acquired through imaging using the camera 20 from the camera 20 as an input. The distance detecting unit 31 detects a position at which the user U is shown in the input image. For example, the distance detecting unit 31 detects a position at which a face of the user U is shown in the input image. The detection of the position of a face is performed using a known face recognition technology represented by OKAO Vision (Omron Corp.), FaceU (PUX), or the like as a base. The distance detecting unit 31 detects a distance from the camera 20 (an imaging position thereof) to the face of the user U in the imaging direction of the camera 20 the basis of the position of the face of the user U in the image. The detection of a distance, for example, is performed by calculating the distance on the basis of the position of the face of the user U in the image, parameters at the time of imaging using the camera 20, and the like. Alternatively, a function of a depth camera may be provided in the camera 20, and a distance to a face of a user U (a detected position) obtained using the function of a depth camera may be acquired.

In addition, in a case in which a position of a user U (a position in a direction other than the imaging direction of the camera 20) imaged by the camera 20 is almost fixed (for example, a user U is constantly positioned in front of the display 10), the position of the user U in the image may be configured not to be detected. In such a case, a distance to a user U at a position set in advance may be detected similar to the case described above. In addition, in such a case, the distance detecting unit 31 may be configured not to be receive an image from the camera 20 as an input. The detection of a distance from the camera 20 to a user U does not need to be performed using the methods described above and may be performed using an arbitrary conventional method. In addition, the distance detecting unit 31 may detect a distance by accepting an input operation to the PC 30 from a manager of the display and imaging device 1, a user U, or the like and receiving information representing a distance from the camera 20 to the user U as an input. The distance detecting unit 31 outputs information representing the detected distance to the depth of field control unit 32.

The depth of field control unit 32 is a functional unit that controls a depth of field D of imaging using the camera 20 in accordance with a distance detected by the distance detecting unit 31. The depth of field control unit 32 may set a focus distance of imaging using the camera 20 that serves as a reference of the depth of field D to be longer than a distance detected by the distance detecting unit 31 in accordance with the distance detected by the distance detecting unit 31. For example, the depth of field control unit 32 controls the depth of field D as below.

The depth of field control unit 32 inputs information representing a distance from the camera 20 to the user U from the distance detecting unit 31. The depth of field control unit 32 sets a depth of field D in accordance with the distance represented by the information. The depth of field D is set such that the display 10 does not enter the range thereof, and the user U enters the range and is clearly imaged without any blurring. By determining the depth of field D such that the display 10 does not enter the range, as illustrated in FIG. 2(b), a ghost image of the periodical structure members and the like of the display 10 can be reduced or eliminated. In addition, according to the setting of the depth of field D using the depth of field control unit 32, the depth of field D becomes shallow, and thus, there is concern that a background and the like other than the user U may be blurred in an image acquired through imaging. However, in a video call, although the background and the like are blurred, there is a little adverse effect thereof.

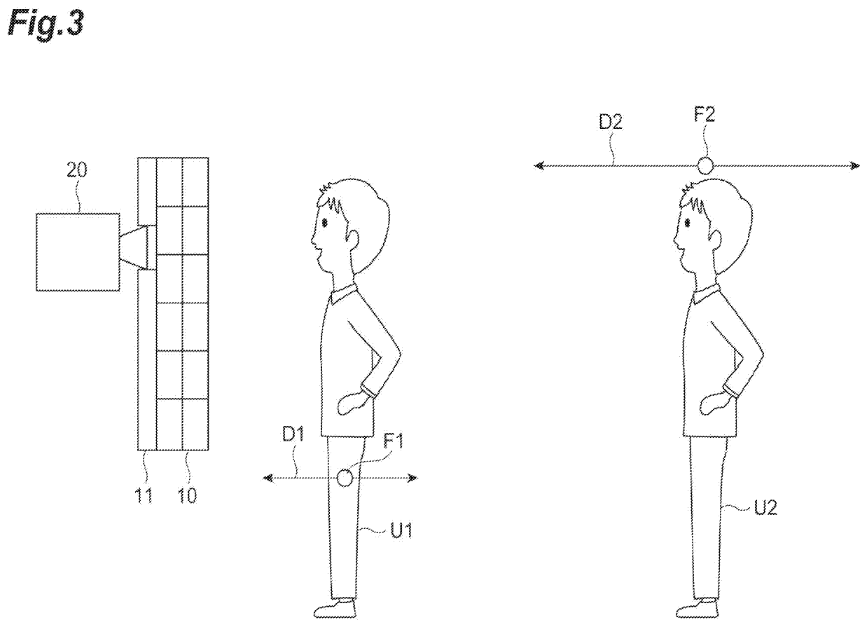

For example, the depth of field control unit 32, first, as illustrated in FIG. 3, sets a focus position F1, F2 that serve as a reference of the depth of field D to a position of user U1, U2. In other words, the depth of field control unit 32 causes a focus distance to the focus position F1, F2 from the camera 20 to match a distance from the camera 20 to the user U1, U2. Subsequently, the depth of field control unit 32 determines a length of the depth of field D. For example, as in the case of the user U1 illustrated in FIG. 3, in a case in which a distance from the camera 20 to the user U1 is short, the depth of field control unit 32 sets a depth of field D1 to be shallow such that the display 10 does not enter the depth of field D1. In addition, as in the case of the user U2 illustrated in FIG. 3, in a case in which a distance from the camera 20 to the user U1 is long, even when the depth of field D2 is set to be deep, the display 10 does not enter the depth of field D2. For this reason, in a case in which the distance from the camera 20 to the user U2 is long, the depth of field control unit 32 sets the depth of field D2 to be deep. By setting the depth of field D2 to be deep, sides in front/to the rear of the user U2, for example, the background of the user U2 and the like can be imaged without blurring.

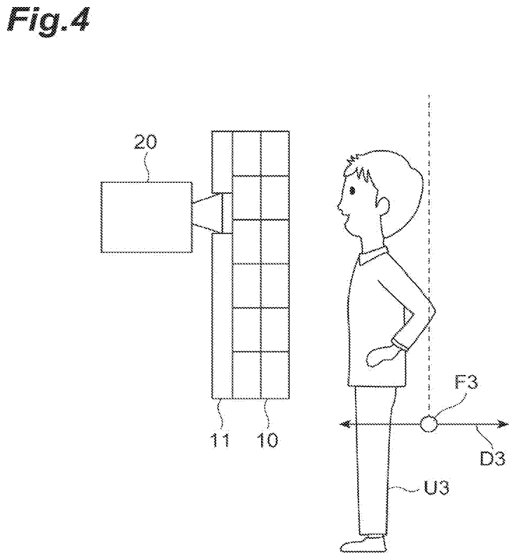

The focus position F that serves as a reference of the depth of field D does not need to be the position of the user U as described above. For example, as in the case of a user U3 illustrated in FIG. 4, in a case in which a distance from the camera 20 to the user U3 is extremely short, the depth of field control unit 32 may set a focus position F3 to a position farther from the camera 20 than the position of the user U3. In other words, the depth of field control unit 32 may set a focus distance from the camera 20 to the focus position F3 to be longer than a distance from the camera 20 to the user U3. In this case, the focus position F3 may be set to be slightly behind the position of the user U3. In addition, the depth of field control unit 32 sets the depth of field D3 to be shallow of a degree such that the display 10 does not enter the depth of field D3, but the user U3 enters the depth of field D3 (a side in front of the focus position F3 (the camera 20 side)).

The depth of field control unit 32 stores a focus position F (a focus distance) and a length of a depth of field D for each distance from the camera 20 to the user U in advance and sets a depth of field D (a focus position F (a focus distance) and a length of a depth of field D) in accordance with a distance represented by information input from the distance detecting unit 31. In addition, the depth of field control unit 32 sets a depth of field D in a range in which the depth of field D of imaging using the camera 20 can be physically controlled.

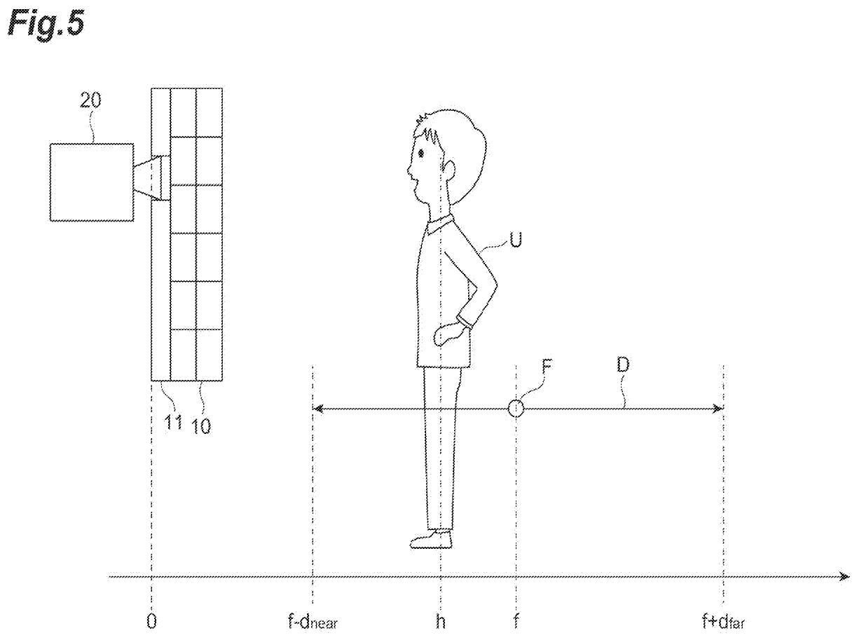

The depth of field D may be set in accordance with the following conditions. As illustrated in FIG. 5, a depth of field D is set as below for a distance h from the camera 20 to the user U, a focus distance f from the camera 20 to the focus position F, a length dₙₑₐᵣ of a depth of field D on the side in front (the camera 20 side) from the focus position F, and a length d_{far} of a depth of field D on the side to the rear (a side away from the camera 20) from the focus position F. On condition that f-dₙₑₐᵣ≤h and f+d_{far}≥h are satisfied (in other words, the position of the user U is included on a side in front of the focus position F of the depth of field D), a depth of field D (a focus position F (a focus distance) and a length of the depth of field D) is set such that f-dₙₑₐᵣ is as large as possible (in other words, the depth of field D is as far away from the display 10 as possible).

However, simply on the condition described above, the depth of field D becomes a minimum (for example, in a case in which the depth of field D is controlled by a diaphragm, an F value becomes a minimum (the diaphragm becomes a maximum)), and thus, in a case in which the user U is a predetermined distance away from the camera 20 or more, the depth of field D may be widened according to applications and the like taken into account.

In a case in which an image acquired through imaging using the camera 20 is a whitish image or a flattened image having no pattern (for example, the background of the user U is a flat wall having no pattern), the periodical structure members and the like shown in the image easily stand out visually. Thus, for example, the depth of field D may be controlled also on the basis of the degree to which the periodical structure members and the like stand out visually in an image acquired through imaging using the camera 20.

In other words, the depth of field control unit 32 may control the depth of field D in accordance also with features of an image acquired through imaging using the camera 20 in addition to the distance from the camera 20 to the user U. More specifically, the depth of field control unit 32 may control the depth of field D in accordance with at least one of a type of object shown in an image, a luminance value (pixel value) of the image, and a frequency component of the image as features of the image. In such a case, the depth of field control unit 32 may control the depth of field D also in accordance with features of at least one of a part of the image acquired through imaging using the camera 20 in which an object is shown and a part in which no object is shown.

In such a case, the depth of field control unit 32 inputs an image acquired through imaging using the camera 20 from the camera 20 as well. The depth of field control unit 32 detects a type of object shown in the image from the input image. In other words, the depth of field control unit 32 performs scene detection of the input image. For example, the depth of field control unit 32 determines a type of object shown in an image by performing image processing, for example, image segmentation. The depth of field control unit 32 determines whether or not a wall is present behind the user U (in the surroundings of the user U in the image) on the basis of the determination. The depth of field control unit 32 determines that the periodical structure members and the like easily stand out visually in a case in which it is determined that a wall is present behind the user U and sets the depth of field D to be shallower than in a case in which it is determined that a wall is not present.

Alternatively, for example, the depth of field control unit 32 calculates an average value of luminance values of pixels of the input image. The depth of field control unit 32 compares the calculated average value of luminance values with a threshold set in advance. In a case in which the calculated average value of the luminance values is equal to or larger than the threshold, the depth of field control unit 32 determines that the acquired image is a whitish image, and the periodical structure members and the like easily stand out visually and sets the depth of field D to be shallower than in a case in which the calculated average value of the luminance values is smaller than the threshold.

Alternatively, for example, the depth of field control unit 32 may perform a Fourier transform on the input image. In accordance with the Fourier transform, the image is configured as a value for each frequency, in other words, frequency components. The frequency components represent a complexity of a texture of an image. In a case in which frequency components of high frequencies are high, this represents that an image is complex (disorganized). In a case in which frequency components of high frequencies are low, it represents that the image is not complex (smooth). The depth of field control unit 32 compares frequency components of high frequencies set in advance with a threshold set in advance. In a case in which there is a frequency component of a high frequency that is equal to or lower than the threshold, the depth of field control unit 32 determines that the acquired image is not complex, and the periodical structure members and the like easily stand out visually and sets the depth of field D to be shallower than in a case in which there is no frequency component of a high frequency that is equal to or lower than the threshold.

The features of the image described above may be used in combination. In addition, the features described above may be features of at least one of a part in which the user U is shown and a part in which the user U is not shown. Differentiation between the part in which the user U is shown and the part in which the user is not shown may be performed using the image segmentation described above. In addition, features of an image used for setting a depth of field D are not limited to those described above, and arbitrary conventional features of an image may be used.

The depth of field control unit 32 performs control of the camera 20 such that the camera performs imaging with the depth of field D set as described above. For example, the depth of field control unit 32 transmits information representing imaging conditions such as a diaphragm (an F value) according to the set depth of field D, other parameters, and the like to the camera 20 and causes the camera 20 to perform imaging with the imaging conditions. The control of the depth of field D using the PC 30, for example, may be performed regularly at predetermined time intervals. The configuration of the display and imaging device 1 according to this embodiment has been described as above.

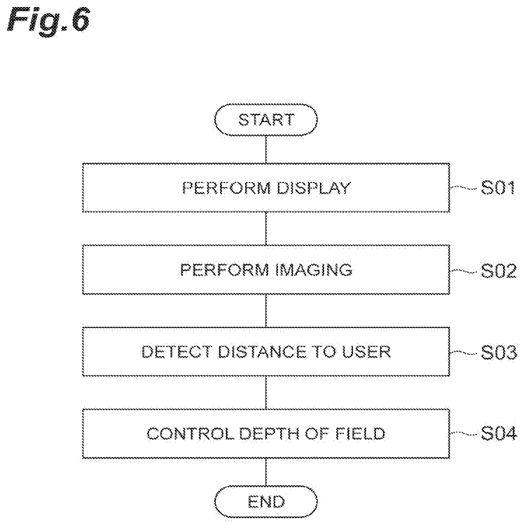

Subsequently, a process executed by the display and imaging device 1 (an operation method performed by the display and imaging device 1) according to this embodiment will be described with reference to a flowchart illustrated in FIG. 6. In this process, an image is input and displayed using the display 10 (S01). The image is, as described above, for example, an image, in which a call partner is shown, acquired through imaging using the call partner-side device. The image is output from the call partner-side device to the display 10 through the PC 30.

In addition, imaging is performed using the camera 20 (S02). In addition, the display using the display 10 (S01) and the imaging using the camera 20 (S02) do not need to be performed in the order described above and may be independently performed. The image acquired through imaging is an image in which the user U is shown. The image is transmitted from the camera 20 to the call partner-side device through the PC 30. In addition, in the PC 30, a distance from the camera 20 to the user U is detected by the distance detecting unit 31 (S03). Subsequently, a depth of field D of the imaging using the camera 20 is controlled in accordance with the distance by the depth of field control unit 32 (S04). The processes (S01 to S04) described above are repeatedly performed. The process executed by the display and imaging device 1 according to this embodiment has been described as above.

As described above, in this embodiment, the depth of field D of imaging using the camera 20 is controlled in accordance with a distance from the camera 20 to the user U. In accordance with this control, a ghost image of members included in the display 10 such as a periodical structure member and the like in the image can be reduced or eliminated. Therefore, according to this embodiment, in a case in which imaging is performed from behind the display 10, deterioration of the image quality can be prevented.

In addition, as in the embodiment described above, a focus distance of imaging using a camera may be set to be longer than a distance from the camera 20 to the user U in accordance with the distance from the distance from the camera 20 to the user U.

According to this configuration, for example, as illustrated in FIG. 4, even in a case in which the distance from the camera 20 to the user U3 is extremely short, the depth of field D can be appropriately set.

In addition, as in the embodiment described above, the depth of field D may be controlled also in accordance with features of the image. According to this configuration, for example, the depth of field D can be appropriately set on the basis of easiness in visual standing-out of a ghost image of a periodical structure member and the like as described above. Furthermore, as in this embodiment, the depth of field D may be controlled in accordance with features of at least one of a part of an image in which the user U is shown and a part in which the user is not shown. According to this configuration, the depth of field D can be appropriately set on the basis of easiness in visual standing-out of a ghost image of a periodical structure member and the like of the part in which the user U is shown or easiness in visual standing-out of a ghost image of a periodical structure member and the like of a part such as a background or the like.

In addition, as in the embodiment described above, a position at which the user U is shown in an image acquired through imaging using the camera 20 may be detected, and a distance from the camera 20 to the user U may be calculated on the basis of the detected position. According to this configuration, a distance can be appropriately calculated regardless of the position of the user U.

In addition, in this embodiment, although the display and imaging device 1 has been described to be used for a video call, the display and imaging device may be used other than for a video call. For example, an image, in which the user U is shown, acquired through imaging using the camera 20 may be displayed on the display 10. In other word, the display and imaging device 1 may be used for self-imaging of the user U. Since the display 10 and the camera 20 are present at the position of the sight line of the user U, the user U can perform imaging while checking how he or she appears. The display and imaging device 1, for example, is used for a camera (a certificate photograph camera, a seal printer, or the like). In this form, there is an advantage that an imaging preview screen can be checked with the sight line directed toward the front face at the time of imaging.

Alternatively, also in a case in which computer graphics (CG) are composed with a video of the user U in an augmented reality (AR) signage placed at a shopping center or the like, the display and imaging device 1 can be used. By using the display and imaging device 1, the AR signage can be enjoyed more naturally. In addition, the display and imaging device 1 may be used also for an application that performs live streaming of a person while showing the person. By using the display and imaging device 1, the live streaming can be performed with a more natural facial expression.

In addition, in this embodiment, although a target object of imaging using the camera 20 (a target for calculating a distance) has been described as a user U making a video call, depending on the use form of the display and imaging device 1, an object other than the user may be set as a target object of imaging using the camera 20.

Each block diagram used for description of the embodiment described above illustrates blocks in units of functions. Such functional blocks (component units) are realized by an arbitrary combination of at least one of hardware and software. In addition, a method for realizing each functional block is not particularly limited. In other words, each functional block may be realized by one device that is combined physically or logically or a plurality of devices by directly or indirectly (for example, using a wire, wirelessly, or the like) connecting two or more devices separated physically or logically. A functional block may be realized by combining software with one device or the plurality of devices described above.

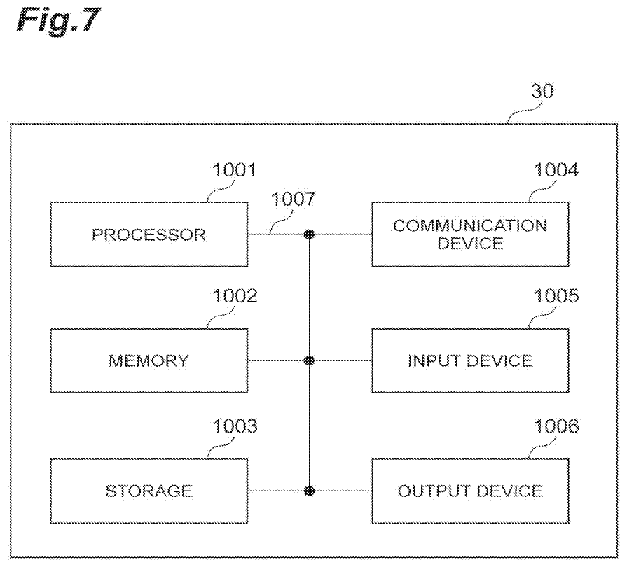

For example, the PC 30 according to one embodiment of the present disclosure may function as a computer that performs the process of the method of the present disclosure. FIG. 7 is a diagram illustrating one example of the hardware configuration of the PC 30 according to one embodiment of the present disclosure. The PC 30 described above, physically, may be configured as a computer apparatus including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the PC 30 may be configured to include one or a plurality of devices illustrated in the drawing and may be configured without including some of these devices.

Each function of the PC 30 may be realized when the processor 1001 performs an arithmetic operation by causing predetermined software (a program) to be read onto hardware such as the processor 1001, the memory 1002, and the like, controls communication using the communication device 1004, and controls at least one of data reading and data writing for the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, each function of the PC 30 described above may be realized by the processor 1001.

In addition, the processor 1001 reads a program (program code), a software module, data, and the like from at least one of the storage 1003 and the communication device 1004 into the memory 1002 and executes various processes in accordance with these. As the program, a program causing a computer to execute at least some of the operations described in the embodiment described above is used. For example, each function of the PC 30 may be realized by a control program that is stored in the memory 1002 and operated by the processor 1001. Although the various processes described above have been described as being executed by one processor 1001, the processes may be executed simultaneously or sequentially by two or more processors 1001. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RANI), and the like. The memory 1002 may be referred to as a register, a cache, a main memory (a main storage device), or the like. The memory 1002 can store a program (a program code), a software module, and the like executable for performing the method according to one embodiment of the present disclosure.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including at least one of the memory 1002 and a storage 1003, a server, or any other appropriate medium.

The communication device 1004 is hardware (a transmission/reception device) for performing inter-computer communication through at least one of a wired network and a wireless network and, for example, may be called also a network device, a network controller, a network card, a communication module, or the like.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the PC 30 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

The input/output information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (′CO″ or “1”) represented by one bit, may be performed using a Boolean value (true or false), or may be performed using a comparison between numerical values (for example, a comparison with a predetermined value).

The aspects/embodiments described in the present disclosure may be individually used, be used in combination, or be switched therebetween in accordance with execution. In addition, a notification of predetermined information (for example, a notification of being X) is not limited to being performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set in accordance with the claims. Thus, the description presented in the present disclosure is for the purpose of exemplary description and does not have any limited meaning for the present disclosure.

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology such as a coaxial cable, an optical fiber cable, a twisted pair, a digital subscriber line (DSL) or the like and a radio technology (infrared rays, microwaves, or the like), at least one of such a wiring technology and a radio technology is included in the definition of the transmission medium.

Information, a signal, and the like described in the present disclosure may be represented using any one among other various technologies. For example, data, a direction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, information, a parameter, and the like described in the present disclosure may be represented using absolute values, relative values from predetermined values, or other corresponding information.

The names used for the parameters described above are not limited names in any aspect. In addition, equations and the like using such parameters may be different from those that are explicitly disclosed in the present disclosure.

Description of “on the basis of” used in the present disclosure does not mean “only on the basis of” unless otherwise mentioned. In other words, description of “on the basis of” means both “only on the basis of” and “at least on the basis of.”

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, a term “A and B are different” may means that “A and B are different from each other”. In addition, the term may mean that “A and B are different from C”. Terms “separated”, “combined”, and the like may be interpreted similar to “different”.

### REFERENCE SIGNS LIST

1 Display and imaging device
10 Display
11 Masking member
20 Camera
31 Distance detecting unit
32 Depth of field control unit
1001 Processor
1002 Memory
1003 Storage
1004 Communication device
1005 Input device
1006 Output device
1007 Bus

1: A display and imaging device comprising:
a display of a transmissive type configured to receive an image as an input and display the image;
a camera configured to image a side in front of the display from behind the display; and
circuitry configured to: detect a distance from the camera to a target object of imaging using the camera; and
control a depth of field of imaging using the camera in accordance with the detected distance.

2: The display and imaging device according to claim 1, wherein the circuitry sets a focus distance of imaging using the camera that serves as a reference of the depth of field to be longer than the detected distance in accordance with the detected distance.

3: The display and imaging device according to claim 1, wherein the circuitry controls the depth of field also in accordance with features of an image acquired through imaging using the camera.

4: The display and imaging device according to claim 3, wherein the circuitry controls the depth of field also in accordance with at least one of a type of target object shown in the image acquired through imaging using the camera, a luminance value of the image, and a frequency component of the image.

5: The display and imaging device according to claim 3, wherein the circuitry controls the depth of field also in accordance with features of at least one of a part of the image acquired through imaging using the camera in which the target object is shown and a part in which the target object is not shown.

6: The display and imaging device according to claim 1, wherein the circuitry detects a position at which the target object is shown in an image acquired through imaging using the camera and detects the distance on the basis of the detected position.

7: The display and imaging device according to claim 2, wherein the circuitry controls the depth of field also in accordance with features of an image acquired through imaging using the camera.
